(19) United States
(12) Patent Application Publication
(10) Pub. No.: US 2015/0288229 A1
(43) Pub. Date: Oct. 8, 2015

(54) ELECTRIC MOTOR WITH IMPROVED INDUCTANCE AND METHOD FOR WINDING AND INTERCONNECTING COILS

(71) Applicant: Elegant Ideas Foundation, Vaduz (LI)

(72) Inventor: Sergey Zatsarinin, Omsk (RU)

(21) Appl. No.: 14/441,222

(22) PCT Filed: Nov. 8, 2012
(86) PCT No.: PCT/EP2012/004648

§ 371 Date: May 7, 2015

(51) Int. Cl. H02K 1/12; H02K 41/03; H02K 15/08; H02K 1/22

(52) U.S. Cl. CPC H02K 1/12; H02K 1/22; H02K 41/03; H02K 15/08

(57) ABSTRACT

The invention relates to electric motors, in particular reluctance motors, including an armature, containing a magnetizable material. The armature has a plurality of pole shoes, an actuator, which is arranged and mounted movably with respect to the armature, contains a magnetizable material and has at least two magnetizable pole ends, and an even number of coils, which are arranged between the pole shoes and of which the windings surround the armature in such a manner that the coils extend in regions along the armature, such that the armature is magnetizable with the aid of the coils.

### CROSS-REFERENCE TO RELATED APPLICATIONS

This application is a Section 371 of International Application No. PCT/EP2012/004648, filed Nov. 8, 2012, which was published in the German language on May 15, 2014, under International Publication No. WO 2014/071960 A1 and the disclosure of which is incorporated herein by reference.

### BACKGROUND OF THE INVENTION

The invention relates to an electric motor, in particular a reluctance motor, comprising an armature containing a magnetizable material, wherein the armature has a plurality of pole shoes, and an actuator, which is arranged and mounted movably with respect to the armature, contains a magnetizable material and has at least two magnetizable pole ends.

The invention also relates to a method for producing an electric motor, in particular a reluctance motor, and the use of an electric motor, in particular a reluctance motor.

The invention belongs to the field of electrical engineering and in particular, relates to reluctance motors with high torque. What will be presented is a design of contact-free electrical reluctance machines (reluctance motors) that can operate in a wide rotational speed range of the machine shaft (from a few revolutions per minute to several hundreds of thousands of revolutions per minute) and in addition can be used in automatic systems, in autonomous electrical equipment systems, in technical room installations, and in air and road traffic as controlled and uncontrolled vehicle motors.

The technical result achieved by application of this invention lies in the benefit of a reliable and technically high-quality construction of the contact-free reluctance motor with high energy values and operating properties with broad rotational speed range of the machine shaft and high specific power. A large number of different electric motors are known from the prior art. Here, a current is passed through coils in order to generate a magnetic field. The magnetic field is usually produced in a magnetizable iron core, which serves as an armature. A rotor that is mounted rotatably in the alternating magnetic fields is itself magnetic or at least magnetizable. An interaction between the alternating fields of the armature and the rotor is thus possible, such that a movement of the rotor is enforced. Alternatively, the armature can also be moved.

Furthermore, a generation of a linear movement by electric motors is also possible, wherein the rotor is then referred to in the present invention as an actuator and is often also referred to in the prior art as a linear rotor. The terms actuator and rotating part are thus equivalent. The armature is also a stator in the sense of the present invention.

Reluctance motors in contact-free embodiments are known. However, these motors have unsatisfactory values in terms of mass and dimensions, and the previous improvement attempts led to a significant complication of the motor construction.

When the coils are switched, the magnetic field is built up or depleted, thus resulting in a hysteresis, which limits the switching speed of the motor. When the inductance is connected into the DC circuit, self-induction voltage is created there (in accordance with Lenz's law), which counteracts the change of the current in the circuit by slowing the current rise and also the current drop when the circuit is opened. The current cannot rise immediately and directly to the nominal value. Consequently, the torque of the motor does not rise very quickly, but asymptotically or exponentially. At low rotational speeds, the current in the motor winding can reach its nominal value after switching off the voltage pulse, and the torque of the motor corresponds approximately to the power parameter. However, when attempting to increase the rotational speed, not only does the speed of the commutation of the windings increase, but the time for which the voltage is applied to the winding reduces. From a critical speed, the current in the winding can no longer rise to the nominal value before the winding is relieved again. This results in a disadvantageous reduction of the torque, the motor starts to skip steps, and ultimately stops.

### BRIEF SUMMARY OF THE INVENTION

The object of the invention is thus to overcome the disadvantages of the prior art. In particular, an electric motor switching as quickly as possible is to be provided. The electric motor is to generate a uniform mean torque where possible, and in the case of rotary motors this is to be provided over the greatest possible range of rotation speed. In addition, the motor is to be structured as simply and economically as possible. Further objects will become clear from the disadvantages of electric motors not according to the invention and from the advantages of motors according to the invention.

The objects of the invention are achieved by an electric motor, in particular, a reluctance motor, comprising an armature containing a magnetizable material, wherein the armature has a plurality of pole shoes, an actuator, which is arranged and mounted movably with respect to the armature, contains a magnetizable material and has at least two magnetizable pole ends, and an even number of coils, which are arranged between the pole shoes and of which the windings surround the armature in such a manner that the coils extends in regions along the armature, such that the armature is magnetizable with the aid of the coils.

The armature has at least two pole shoes. Two pole shoes can be sufficient for an annular armature.

Here, the coils can be electrically interconnected in such a manner that when an electrical voltage is applied to the coils the magnetic fields generated by two coils adjacent to one pole shoe are oriented in such a manner that the same magnetic polarization is produced by both coils at the pole shoe arranged therebetween.

This can be achieved for example in that two adjacent coils are wound in opposite directions and are connected in series. Alternatively, it is also possible to wind two adjacent coils in the same direction and to connect these in parallel. An oppositely directed winding of the coils is achieved in that one coil is wound to the left and the other is wound to the right on the armature. One coil thus has a left-hand winding and the other coil has a right-hand winding.

Due to the interconnection of the coils according to an embodiment of the invention, the induced magnetic fields, and therefore the mutually induced electrical currents in the coils compensate for one another, such that undesirable inertial effects of the motor according to an embodiment of the invention are avoided.

The coils on the armature can be connected electrically in pairs running in opposite direction and magnetically in pairs in parallel (running in the same direction).

In accordance with an embodiment of the invention, the armature and/or the actuator may also consist of a magnetizable material and/or the magnetizable material of the armature and/or of the actuator may have a magnetic permeability of at least 100 H/m, preferably a magnetic permeability of at least 1,000 H/m, and particularly preferably a magnetic permeability of at least 10,000 H/m.

At these values an electric motor according to an embodiment of the invention can be operated with a high level of efficiency.

The number of pole shoes may also be equal to the number of pole ends.

This arrangement is particularly suitable for reluctance motors according to embodiments of the invention with rotatable armature.

Furthermore, the number of coils may be equal to the number of pole shoes and/or the number of coils may be an integer multiple of the number of pole shoes.

In accordance with a particularly preferred embodiment of the invention, the armature may be annular. The annular armature has an even number of pole shoes and the actuator is a rotor, which is mounted rotatably relative to the annular armature. The rotor is preferably mounted rotatably within the annular armature. The coils extend in regions along the periphery of the annular armature, such that the annular armature is magnetizable with the aid of the coils.

Due to the high symmetry of an annular armature, the teaching according to an embodiment of the invention has a particularly advantageous effect. The higher the symmetry of the coils, the better these coils are coupled to one another, such that fewer disturbing induction currents occur.

In the case of such electric motors, the rotor may have an integer number of magnetizable poles.

This embodiment also contributes to the advantageous symmetry of the structure.

In addition, as many coils corresponding to an integer multiple of the number of pole shoes can be arranged one between two pole shoes around the annular armature.

With this structure, more than one coil can also be arranged between the pole shoes.

In accordance with an embodiment of the invention, the annular armature and/or the rotor may have an even-numbered rotational symmetry about the axis of rotation of the rotor, which is equal to the even number of pole shoes of the annular armature and/or the even number of pole ends of the rotor.

The symmetry of the overall structure, and, in particular, the symmetry of the magnetizable structures, are also further improved as a result, which leads to a further acceleration of the switching behavior of the motor according to an embodiment of the invention.

A drive axis may also be arranged in the rotary axis of the rotor, about which drive axis the rotor is mounted rotatably in the annular armature.

In accordance with an alternative embodiment of the invention, the electric motor may be a linear motor with a linear armature, and the linear armature may have an odd number of pole shoes. At least one coil is arranged between each pole shoe, and preferably one coil is arranged between each pole shoe.

The outer pole shoes of the armature of the linear motor do not contribute to the movement of the actuator. The magnetic fields emanating from the outer pole shoes are weaker than the magnetic fields emanating from the inner pole shoes, which are flanked on either side by coils. According to an embodiment of the invention, it is preferable that the structure of the armature of the linear motor is symmetrical at least in respect of the number and form of the poles, and with respect to a mirror plane in the middle of the armature perpendicularly to the linear extent of the armature.

The use of a linear motor according to the invention has the same advantages as the use as rotation motor.

Here, the linear armature may have one pole shoe more than the number of coils wound on the linear motor, and exactly one coil may be arranged between two adjacent pole shoes of the armature.

This measure provides the symmetrical structure of the motor with the advantages already discussed.

In accordance with an embodiment of the invention, the same number of coil windings may also always be wound by the coils between two pole shoes of the armature.

The symmetry of the coils with respect to one another is thus increased.

Here, the number of windings of the coils between all pole shoes can be identical apart from at least 45° of a winding, and preferably can be identical apart from at least 45°, and particularly preferably can be identical apart from at least 5°, and, as a result, a further improvement of the symmetry of the structure is achieved.

With motors according to an embodiment of the invention, the electrical conductor from which the coils are wound may generally have a uniform cross section in accordance with an embodiment of the invention, and in particular a cross section having a deviation of at most 20%, preferably of at most 10%, and particularly preferably of at most 2%.

Since this is beneficial for the symmetry of the electron flow through the coil windings, this measure is also suitable for the further improvement of the installation according to an embodiment of the invention.

In accordance with an embodiment of the invention, the magnetizable material of the armature and/or of the actuator may also include electrically conductive layers, which are electrically insulated from one another, preferably from steel layers electrically insulated from one another, wherein an insulator is arranged between the electrically conductive layers, and plastic layers are preferably arranged between the electrically conductive layers.

A material that can be magnetized particularly well is thus provided, with which material the efficiency of a structure according to an embodiment of the invention can be further improved.

The objects forming the basis of the invention are also achieved by a method for producing an electric motor, in particular a reluctance motor, preferably in accordance with one of the preceding claims, in which an even number of coils are applied to an armature containing a magnetizable material, wherein the coils are arranged between a plurality of pole shoes, such that the windings of the coils surround the armature in such a manner that the coils extend in regions along the armature, and an actuator containing a magnetizable material comprising at least two pole ends is mounted movably with respect to the armature.

Here, the coils can be electrically interconnected in such a manner that when an electrical voltage is applied to the coils the magnetic fields generated by two coils which are adjacent to a pole shoe are oriented in such a manner that, at the pole shoe arranged therebetween, the same magnetic polarization is produced at the pole shoe by the two adjacent coils.

Methods according to an embodiment of the invention can also be characterized by the provision of all suitable features of the electric motor that have already been discussed previously.

Lastly, the findings forming the basis of an embodiment of the invention are also provided by the use of an electric motor of this type, in particular a reluctance motor of this type, for driving a movement of a device or part of a device.

Embodiment of the invention are based on the surprising finding that the coils are not wound around the pole shoe of the armature of the reluctance motor, but around the armature itself. The induction currents in the coils of the electric motor can thus compensate for one another. This is particularly advantageous with a suitable interconnection of the coils.

As a result of the invention, a significant reduction of the inductance of the armature winding is achieved, which leads to an increase of the speed of the current rise in the armature winding, and consequently, also the switching frequency of the current in the armature winding, the rotational speed of the rotor and thus enables a higher delivered and specific power of the electric motor. The reduction of the inductance of the armature winding, which lies in a two-digit range, additionally provides the input resistance of the armature coil with an active character, and largely rules out the creation of disturbing self-induction voltages, which significantly increases the reliability of the work of switching steps of the electronic switch. Furthermore, the motor can be fed with significantly less voltage, which is achieved by an almost complete absence of the reactance of the armature winding. A disturbing emission of electromagnetic waves by the motor both through the air and through the electrical lines can also be avoided to an extremely large extent by an electric motor according to an embodiment of the invention. The electric motor according to an embodiment of the invention can thus also be used together with sensitive electronics or in sensitive environments, which normally respond in a sensitive manner to such interference.

The present reluctance motor thus has the following advantages:

Simple construction: the rotor and the stator are formed as laminated cores of soft-magnetic sheet metal material. The rotor has no windings or permanent magnets. Only the stator has windings. In order to reduce the outlay, the coils of the armature windings can be fabricated separately and placed later onto the separated magnet body of the armature.

A high specific power of the motor is linearly proportional to the square of the rotational speed and in the present electric motors is limited only by the stability of the structure and the strength of the materials. The expected power may lie in the two-digit kW range per 1 kg of the motor. This power per kg of the motor cannot be achieved by other electric motors.

No mechanical switch: the actuating solenoid of the electric motor is controlled by highly effective semiconductor power switches—transistors, IGBTs or MOSFETs (HEXFETs), of which the stability and reliability is significantly greater than that of any mechanical parts; for example collectors, brushes, bearings.

No permanent magnets: reluctance motors do not have any permanent magnets, either in the rotor or in the stator, and therefore the electric motor according to an embodiment of the invention with the power features thereof can compete successfully with brushless motors with permanent magnets, and can therefore be constructed much more simply. With identical electrical data and also in respect of weight and/or dimensions, the reluctance motor on average costs 4 times less, has much higher stability, a broader rotational speed range, and a broader operating temperature range. In terms of the design principle, the reluctance motor in principle does not have any power limitations.

The rotor does not have any windings and can be formed as a laminated core consisting of soft-magnetic sheet metal material, and, for example, consisting of conventional electrical sheet steel.

For the production of the reluctance motor, 2 to 3 times less copper is required than for collector motors of identical power, and 1.3 times less copper is required than for an asynchronous motor.

The heat develops primarily in the stator (armature), and in this case air or water cooling can be easily provided by means of a sealed construction. In the operating state, the rotor does not require any cooling. In order to cool the reluctance motor, the cooling of the outer stator surface (armature surface) is sufficient.

The reluctance motor according to an embodiment of the invention can be produced with a hollow rotor. Here, the thickness of the rotor back must be at least half the pole width. The mass/dimensions of the electric motor, power thereof at the target torque, and rotational speed range can be optimized by coordinating the stator and rotor pole number.

The simplicity of the construction of the reluctance motor according to an embodiment of the invention reduces the complexity of the production thereof. In principle, it may even be produced in plants that are not specialized in the field of manufacture of electric machines. For series manufacture of reluctance motors, only one common mechanical equipment set-up is needed—punching in order to fabricate the stator and rotor sheet metal cores, and turning and milling machines for machining the shaft and housing parts are already sufficient. The construction according to an embodiment of the invention lacks complex and technically complicated production steps, such as the production of a collector and brushes of the collector motor or a lining of the rotor cage of the asynchronous motor. According to preliminary estimations, the cost and time involved in producing a reluctance motor are 70% less than in the case of the collector motor and 40% less than in the case of an asynchronous motor.

A further advantage can be seen in the versatile design. Thanks to the simplicity of the armature winding and the absence of windings and magnets on the rotor, high versatility of the design of the reluctance motor is ensured. The structure of the electric motor can be flat, elongated, inverse or linear. In order to produce an entire series of electric motors of different power, the same punch set for punching out the rotor and stator (armature) can be used, since for a power increase it is sufficient to enlarge the length of the rotor set and stator set accordingly. It is not difficult to fabricate the machine with the stator outside the rotor and vice versa, nor is it difficult to incorporate the electronics in the machine housing.

The simplicity of the construction provides the reluctance motor with greater reliability than that of the other types of electric machines.

A broad rotational speed range (from a few revolutions per minute to hundreds of revolutions per minute) can be provided with the electric motor according to the invention.

A high utility is achieved in a broad rotational speed range, since the coil does not generate any counterforce.

A comfortable connection to modern digital electronics is possible with electric motors according to the invention.

Because reluctance motors according to an embodiment of the invention are fed (excited) by unipolar pulses, a simple electronic switch is sufficient for control. By means of control of the pulse switching ratio of high-current transistors of the electronic switch, the form of the current pulses of phase windings of the electric motor can be changed continuously.

The natural mechanical characteristic of the reluctance motor is determined by the reaction principle of the operation of the electric machine and assimilates a hyperbola form. The main feature of this characteristic (a mean power constancy at the machine shaft) has proven to be extraordinarily useful for electric drives with limited source power, since here the condition that they can be operated at low load is provided. The use of a closed control system with feedback according to speed and load makes it possible to obtain mechanical characteristics of any predefined form, including absolutely rigid forms (astatic forms), and does not lead to a complication of the control system, since the processor thereof has great redundancy of speed and memory. The field of the mechanical characteristics accessible in accordance with an embodiment of the invention covers all four quadrants of the torque-speed-plane practically continuously within the limitation area of a specific electric drive.

The price for a reluctance motor is the lowest of all known constructions of electric motors. Lastly, the efficiency of the reluctance motor according to an embodiment of the invention rises as a result of the much smaller energy consumption, which is caused by the high efficiency of the electric motor and application of the economy control strategies in dynamic operation.

Due to the contact-free circuit, high mechanical load-bearing capability and strength of the rotor can be offered by the reluctance motor according to an embodiment of the invention primarily for vehicle systems that are operated under particularly difficult use conditions (for example cars, off-road vehicles, industrial tractors). It can also be used in industrial facilities. Good industrial and commercial applicability of the solution according to an embodiment of the invention is thus provided.

Electric motors according to an embodiment of the invention, for example, are electric motors including an armature core with salient armature poles, fabricated as laminated core consisting of insulated electrical sheet steel, wherein the number of armature poles is at least 2n (n is an integer) and the armature winding is located between salient poles of the armature, on the magnet body, in which an armature winding each coil wraps around the magnet body between salient poles of the armature. The winding-free rotor contains the shaft, on which the magnet body of the rotor with pole edges is located, fabricated as laminated core consisting of insulated electrical sheet steel, the number of the rotor poles is equal to the number of armature poles.

The efficiency of the armature of the reluctance motor according to an embodiment of the invention is characterized in that the armature winding consists of two identical coils with identical number of windings and cable of identical cross section, which coils have the opposite winding direction and are arranged in succession, such that the operating current flowing through the specified coils generates a solenoid current through poles of the same direction. Such a connection of the coils (bifilar) is characterized by minimal possible overall inductance and almost complete compensation of the self-induction voltage of individual coils. The coils of the armature winding thus produce twice the solenoid current in armature poles. Here, they have minimal inductance and no self-induction voltage at winding ends, wherein the operating properties of the electric motor can be considerably improved, and high energy index with broad rotational speed range of the shaft and high specific power can be achieved.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows a schematic perspective view of an electric motor according to an embodiment of the invention with two pole shoes;

FIG. 2 shows a schematic perspective view of an electric motor according to an embodiment of the invention with four pole shoes;

FIG. 3 shows a schematic perspective view of an elongate electric motor according to an embodiment of the invention with two pole shoes;

FIG. 4 shows a schematic perspective view of an electric motor according to an embodiment of the invention with two pole shoes, in which the rotor is arranged externally around the armature;

FIG. 5 shows a schematic perspective view of an electric motor according to an embodiment of the invention with two pole shoes, in which a number of units are connected to a rotor axis;

FIG. 6 shows a schematic perspective view of a linear motor according to an embodiment of the invention; and

FIG. 7 shows a diagram of an oscilloscope, which has been received on a motor according to an embodiment of the invention according to FIG. 2.

### DETAILED DESCRIPTION OF THE INVENTION

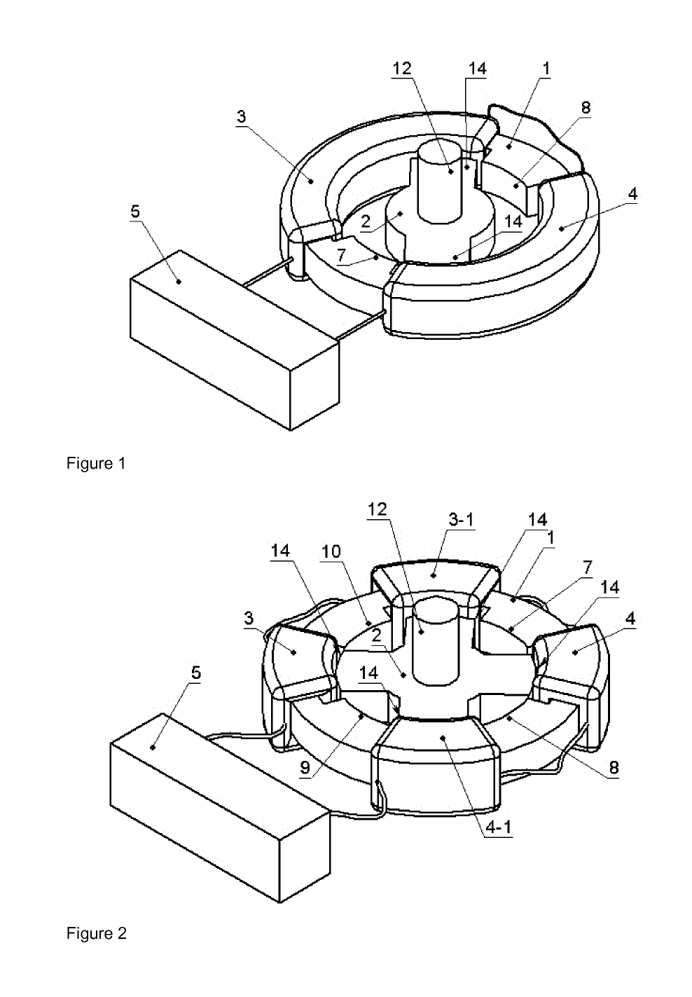

FIG. 1 shows a perspective illustration of a reluctance motor according to an embodiment of the invention. The reluctance motor has an annularly closed armature 1 made of laminated steel. A rotor 2 is arranged inside the annular armature 1, in which the rotor is mounted rotatably in the annular armature 1 and is likewise fabricated from laminated steel. Two coils 3, 4 are wound opposite one another onto the annular armature 1 and extend along the periphery of the annular armature 1, i.e. along the elongate extent of the armature 1. The coils 3, 4 are wound from copper and are surrounded by a housing. Strictly speaking, only the housing around the coils 3, 4 can be seen in FIG. 1.

The windings of the wire are wound around the torus surface of the annular armature 1. The annular armature 1 may be present initially in two parts and may only be joined together once the 2 coils 3, 4 have been wound to form the shown torus.

A control unit 5 is used to control the voltage supply of the coils 3, 4. Two pole shoes 7, 8 are formed on the annular armature 1 between the coils 3, 4 and extend in regions into the interior of the annular armature 1 in the direction of the rotor 2. The coils 3, 4 are wound in opposite directions and are connected in series. The coils 3, 4 are thus arranged in a mirror image in relation to one another on the annular armature 1. As a result of this arrangement and interconnection of the coils 3, 4, an opposite and alternating magnetic polarity is generated at the two pole shoes 7, 8.

The stated object of the invention is thus solved, for example, in that the stator/armature 1 of the contact-free electric machine according to FIG. 1 has an armature core with salient pole shoes 7, 8 of the annular armature 1, which is fabricated as a laminated core from electrical sheet steel, of which the layers are insulated from one another, wherein the number of armature pole shoes 7, 8 is at least two or can be divided by two. The armature winding, in which each coil 3, 4 surrounds the magnet body 1 between the salient pole shoes 7, 8 of the armature 1, is located between salient pole shoes 7, 8 of the armature 1, on the magnet body 1. The coils 3, 4 of the armature winding are connected in pairs with oppositely directed electric current and are connected in pairs with parallel solenoid current. The winding-free rotor 2 contains the shaft 12 as rotary axis of the rotor 2, on which the magnet body of the rotor 2 with pole edges 14 is located. The rotor 2 is likewise fabricated as a laminated core consisting of insulated electrical sheet steel, wherein the number of rotor pole ends 14 is equal to the number of armature poles 7, 8.

The armature winding consists of two identical coils 3, 4 with an identical winding number fabricated from a wire with uniform cross section within the limits of the production method, such as the winding device. The coils 3, 4 have an opposite winding direction, i.e. an opposite winding, and are thus connected in succession such that the operating current flowing through the specified coils generates a solenoid current that causes a magnetic polarization in the same direction of the pole shoes 7, 8. For example: north pole 7 and south pole 8. If the current direction is reversed, the magnet poles are changed in the opposite direction. The armature 1 of this motor is a magnetizable toroidal magnet body (magnet ring) with two (or divisible by 2) identical windings, which are arranged symmetrically on the magnet body, are connected in the opposite direction (variant of bifilar winding), and are coupled to one another by almost total mutual induction.

Such a connection of the coils 3, 4 (bifilar connection) is characterized by a minimal possible overall inductance and almost complete compensation of the self-induction voltage of individual coils 3, 4. The stated object is achieved in this way—the coils 3, 4 of the armature winding generate twice the solenoid current in the armature pole shoes 7, 8. Here they have minimal inductance and do not cause any self-induction voltage at winding ends. The total inductance and the resultant self-induction voltage of the structure are determined by the similarity of the electrical and geometric properties of the coils 3, 4.

The motor feed, generation of operating current pulses, and synchronization of the phase of the operating current pulse delivery are implemented by the control unit 5 in accordance with signals of a position sensor (not shown in FIG. 1) of the rotor 2 and is without special features.

FIG. 2 shows a schematic perspective illustration of an electric motor according to an embodiment of the invention having four pole shoes 7, 8, 9, 10. The electric motor has an armature core with salient pole shoes 7, 8, 9, 10 of the annular armature 1, which is fabricated as a laminated core consisting of layers of electrical sheet steel insulated from one another, wherein the number of the armature pole shoes 7, 8, 9, 10 is divisible by two. The armature winding, in which each coil 3, 4, 3-1, 4-1 surrounds the magnet body 1 between the salient pole shoes 7, 8, 9, 10 of the armature 1, is located between salient pole shoes 7, 8, 9, 10 of the armature 1, on the magnet body 1. The coils 3, 4, 3-1, 4-1 of the armature winding are connected in pairs with oppositely directed electric current and in pairs with parallel solenoid current. The winding-free rotor 2 contains the shaft 12 as rotary axis of the rotor 2, on which the magnet body of the rotor 2 with pole edges 14 is located. The rotor 2 is likewise fabricated as a laminated core consisting of insulated electrical sheet steel, wherein the number of the rotor pole ends 14 is the same as the number of the armature poles 7, 8, 9, 10.

The armature winding consists of four identical coils 3, 4, 3-1, 4-1 with identical winding number fabricated from a wire with uniform cross section within the limits of the production method, such as the winding device. The coils 3, 4, 3-1, 4-1 have an opposite winding direction, i.e. an opposite winding, and are connected in succession such that the operating current flowing through the specified coils 3, 4, 3-1, 4-1 generates a solenoid current that causes a magnetic polarization in the same direction of the pole shoes 7, 9 and of the pole shoes 8, 10, for example, north poles 7 and 9 and south poles 8 and 10. If the current direction is reversed, the magnet poles are changed in the opposite direction.

It is clear from an embodiment of the invention that a greater integer number of pole shoes and coils can also easily be provided.

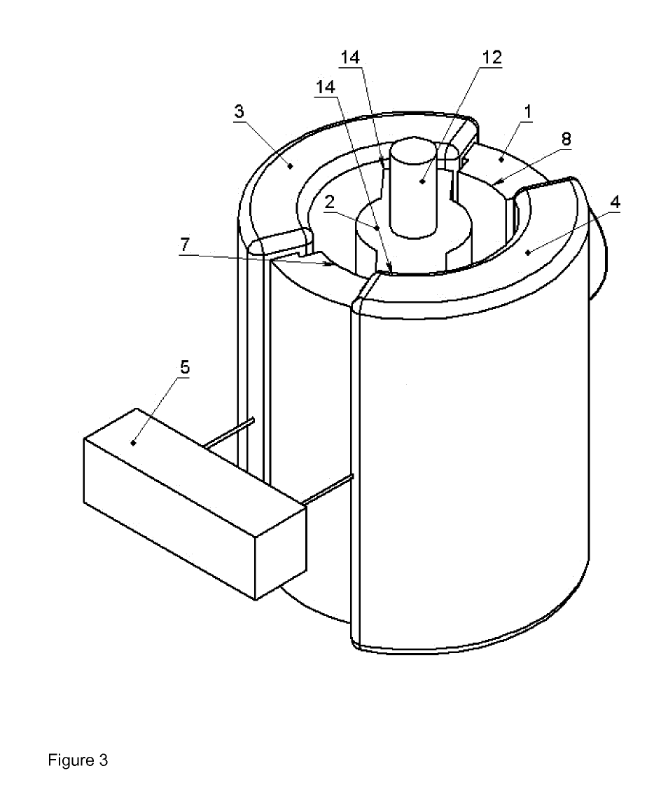

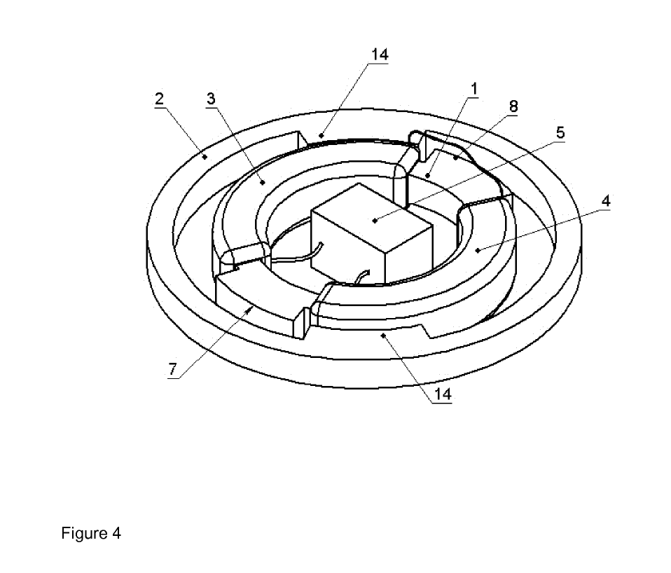

FIG. 3 shows a schematic perspective illustration of an elongated electric motor according to an embodiment of the invention having two pole shoes 7, 8. The electric motor has an armature core with salient pole shoes 7, 8 of the annular armature 1, which is fabricated as a laminated core consisting of layers of electrical sheet steel insulated from one another, wherein the number of armature pole shoes 7, 8 is divisible by two. The armature winding, in which each coil 3, 4 surrounds the magnet body 1 between the salient pole shoes 7, 8 of the armature 1, is located between salient pole shoes 7, 8 of the armature 1, on the magnet body 1. The coils 3, 4, of the armature winding are connected in pairs with oppositely directed electric current and in pairs with parallel solenoid current. The winding-free rotor 2 contains the shaft 12 as rotary axis of the rotor 2, on which the magnet body of the rotor 2 with pole edges 14 is located. The rotor 2 is likewise formed as a laminated core consisting of insulated electrical sheet steel, wherein the number of the rotor pole ends 14 is equal to the number of the armature poles 7, 8.

The armature winding consists of two identical coils 3, 4 with identical winding number fabricated from a wire with uniform cross section within the limits of the production method, such as the winding device. The coils 3, 4 have an opposite winding direction, i.e. an opposite winding, and are connected in succession such that the operating current flowing through the specified coils 3, 4 generates a solenoid current that causes a magnetic polarization in the same direction of the pole shoes 7, 8, for example, north pole 7 and south pole 8. If the current direction is reversed, the magnet poles are changed in the opposite direction.

Elongated and also flat motors can thus be provided with the invention.

FIG. 4 shows a schematic perspective illustration of an electric motor according to an embodiment of the invention having two pole shoes 7, 8, in which the rotor 2 is arranged externally around the armature 1. The electric motor has an armature core with salient pole shoes 7, 8 of the annular armature 1, which is fabricated as a laminated core consisting of layers of electrical sheet steel insulated from one another, wherein the number of armature pole shoes 7, 8 is divisible by two. The pole shoes 7, 8 are directed here outwardly in the direction of the rotor 2. The armature winding, in which each coil 3, 4 surrounds the magnet body 1 between the salient pole shoes 7, 8 of the armature 1, is located between salient pole shoes 7, 8 of the armature 1, on the magnet body 1. The coils 3, 4 of the armature winding are connected in pairs with oppositely directed electric current and in pairs with parallel solenoid current. The winding-free rotor 2 contains the shaft 12 as rotary axis of the rotor 2, on which the magnet body of the rotor 2 with pole edges 14 is located. The rotor 2 is likewise formed as a laminated core consisting of insulated electrical sheet steel, wherein the number of the rotor pole ends 14 is equal to the number of the armature poles 7, 8.

The armature winding consists of two identical coils 3, 4 with identical winding number fabricated from a wire with uniform cross section within the limits of the production method, such as the winding device. The coils 3, 4 have an opposite winding direction, i.e. an opposite winding, and are connected in succession such that the operating current flowing through the specified coils 3, 4 generates a solenoid current that causes a magnetic polarization in the same direction of the pole shoes 7, 8, for example: north pole 7 and south pole 8. If the current direction is reversed, the magnet poles are changed in the opposite direction.

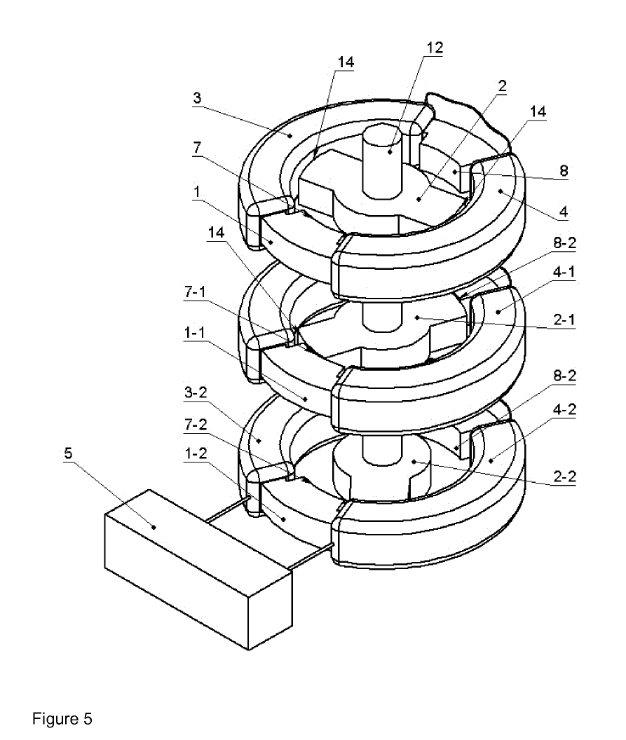

FIG. 5 shows a schematic perspective illustration of an electric motor according to an embodiment of the invention having in each case two pole shoes 7, 8, 7-1, 8-1, 7-2, 8-2, in which a plurality of units are connected to a rotor axis 12. The pole ends 14 of the rotors 2, 2-1, 2-2 are offset in relation to one another, such that a torque can always be generated on the rotor axis 12. The electric motor has three armature cores with salient pole shoes 7, 8, 7-1, 8-1, 7-2, 8-2 of the annular armature 1, 1-1, 1-2, which is fabricated as a laminated core consisting of layers of electrical sheet steel insulated from one another, wherein the number of the armature pole shoes 7, 8, 7-1, 8-1, 7-2, 8-2 is divisible by two for each of the three parts. The pole shoes 7, 8, 7-1, 8-1, 7-2, 8-2 are directed here inwardly in the direction of the rotors 2, 2-1, 2-2. The armature windings, in which each coil 3, 4, 3-1, 4-1, 3-2, 4-2 surrounds the magnet body 1, 1-1, 1-2 between the salient pole shoes 7, 8, 7-1, 8-1, 7-2, 8-2 of the armature 1, 1-1, 1-2, is located between salient pole shoes 7, 8, 7-1, 8-1, 7-2, 8-2 of the armature 1, 1-1, 1-2, on the magnet body 1, 1-1, 1-2. The coils 3, 4, 3-1, 4-1, 3-2, 4-2 of the armature winding are connected in pairs with oppositely directed electric current and in pairs with parallel solenoid current. The winding-free rotors 2, 2-1, 2-2 are connected centrally to the shaft 12 as rotary axis of the rotors 2, 2-1, 2-2, on which the magnet bodies of the rotors 2, 2-1, 2-2 with pole edges 14 are located. The rotors 2, 2-1, 2-2 are likewise fabricated as a laminated core consisting of insulated electrical sheet steel, wherein the number of the rotor pole ends 14 is the same as the number of the armature poles 7, 8, 7-1, 8-1, 7-2, 8-2.

The armature windings each consist of two identical coils 3, 4, 3-1, 4-1, 3-2, 4-2 with identical winding number fabricated from a wire with uniform cross section within the limits of the production method, such as the winding device. The coils 3, 4, 3-1, 4-1, 3-2, 4-2 have an opposite winding direction, i.e. an opposite winding, and are connected in succession such that the operating current flowing through the specified coils 3, 4, 3-1, 4-1, 3-2, 4-2 generates a solenoid current that causes a magnetic polarization in the same direction of the pole shoes 7, 8, 7-1, 8-1, 7-2, 8-2. For example: north poles 7, 7-1, 7-2 and south poles 8, 8-1, 8-2. If the current direction is reversed, the magnet poles are changed in the opposite direction.

The features of the exemplary embodiments of the invention according to FIGS. 1 to 5 can be easily combined with one another and expanded by one another, such that a large number of different embodiments of the invention are conceivable.

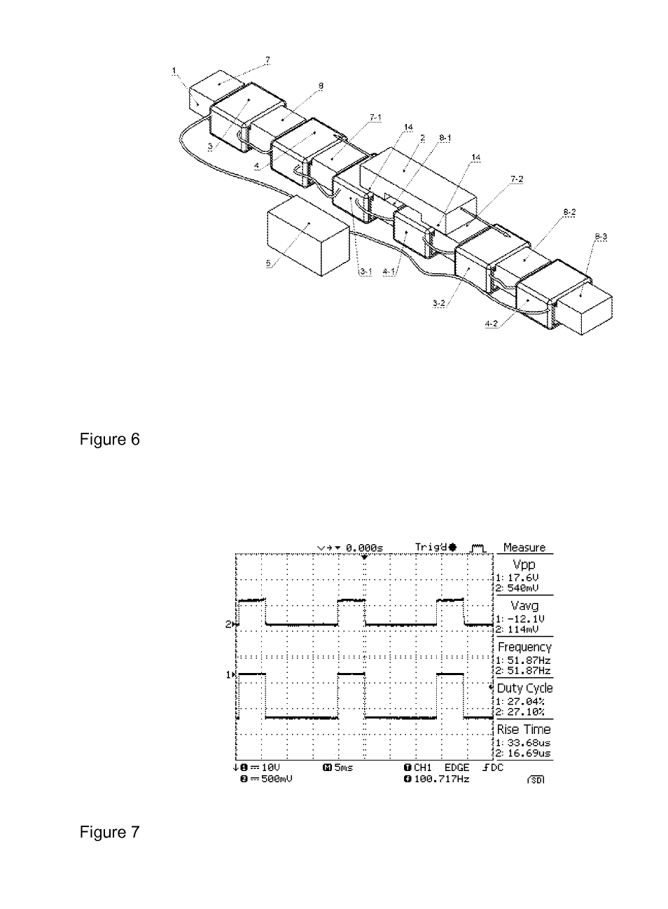

FIG. 6 shows a schematic perspective illustration of a linear motor according to an embodiment of the invention with an armature 1 and a row of pole shoes 7, 8, 7-1, 8-1, 7-2, 8-2, 8-3 constructed linearly in succession and with coils 3, 4, 3-1, 4-1, 3-2, 4-2. A linear rotor 2 or actuator 2 can be moved back and forth on the armature 1. By way of example, automatic doors, sliding doors, robot arms, etc. can be actuated using this linear motor.

The electric motor has an armature core with seven salient pole shoes 7, 8, 7-1, 8-1, 7-2, 8-2, 8-3 of the linear armature 1, which is fabricated as a laminated core consisting of layers of electrical sheet steel insulated from one another, wherein the number of armature pole shoes 7, 8, 7-1, 8-1, 7-2, 8-2, 8-3 is odd, i.e. is not divisible by two. The armature winding, in which each coil 3, 4, 3-1, 4-1, 3-2, 4-2 surrounds the magnet body 1 between the salient pole shoes 7, 8, 7-1, 8-1, 7-2, 8-2, 8-3 of the armature 1, is located between salient pole shoes 7, 8, 7-1, 8-1, 7-2, 8-2, 8-3 of the armature 1, on the magnet body 1. The coils 3, 4, 3-1, 4-1, 3-2, 4-2 of the armature winding are connected in pairs with oppositely directed electric current and in pairs with parallel solenoid current. The winding-free rotor 2 comprises two pole edges 14. With the structure as a linear motor, it is possible to provide the rotor with an odd number of pole edges (not shown in FIG. 6). The rotor 2 is also fabricated as a laminated core consisting of insulated electrical sheet steel, wherein the number of rotor pole ends 14 is independent here of the number of armature poles 7, 8.

The armature winding consists of six identical coils 3, 4, 3-1, 4-1, 3-2, 4-2 with identical winding numbers fabricated from a wire with uniform cross section within the limits of the production method, such as the winding device. The coils 3, 4, 3-1, 4-1, 3-2, 4-2 have an opposite winding direction, i.e. an opposite winding, and are connected in succession such that the operating current flowing through the specified coils 3, 4, 3-1, 4-1, 3-2, 4-2 generates a solenoid current that causes an alternating magnetic polarization of the pole shoes 7, 8, 7-1, 8-1, 7-2, 8-2, 8-3, for example: north poles 7, 7-1, 7-2, 8-3 and south poles 8, 8-1, 8-2. If the current direction is reversed, the magnet poles are changed in the opposite direction.

For the purpose of checking the power capability of the subject matter of the invention, the pattern of the described motor according to FIG. 2 was fabricated and confirmed the advantageous motor properties. FIG. 7 shows an oscillogram of voltage pulses applied to the armature winding (CH1) and of the current (CH2), generated by this voltage, through the armature winding. As can be seen from the oscillogram, the front length of the current pulse through the armature winding is 0.016 ms and is determined substantially on the basis of the front length of the pulse of the applied voltage, which enables an almost complete absence of the inductance of the armature winding and thus in practice the consideration of the active resistance. With such a front length of the current pulse through the armature winding, the pulse period of the feed of 0.1 ms is quite achievable, which enables 10,000 pulses per second. With four poles of the armature and rotor, the rotor speed can be 150,000 revolutions per minute

The features of the invention disclosed in the above description and in the claims, figures and exemplary embodiments may be essential both individually and in any combination for the implementation of the invention in the various embodiments thereof.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-20. (canceled)

21. An electric motor, in particular a reluctance motor, comprising:
an armature, containing a magnetizable material, wherein the armature has a plurality of pole shoes,
an actuator, which is arranged and mounted movably with respect to the armature, contains a magnetizable material and has at least two magnetizable pole ends, and
an even number of coils, each of which being arranged between the plurality of pole shoes, wherein windings surround the armature in such a manner that the even number of coils extend in regions along the armature, such that the armature is magnetizable with the aid of the even number of coils.

22. The electric motor according to claim 21, wherein the even number of coils are electrically interconnected in such a manner that, when an electrical voltage is applied to the even number of coils, the magnetic fields generated by two coils of the even number of coils, adjacent to one pole shoe of the plurality of pole shoes are oriented such that the same magnetic polarization is produced by the two coils at the one pole shoe arranged therebetween.

23. The electric motor according to claim 21, wherein the even number of coils on the armature are connected electrically in pairs in opposite directions and magnetically in pairs in parallel.

24. The electric motor according to claim 21, wherein the armature or the actuator includes a magnetizable material or the magnetizable material of the armature or of the actuator has a magnetic permeability of at least 100 H/m.

25. The electric motor according to claim 21, wherein a number of the plurality of pole shoes is identical to the number of the at least two magnetizable pole ends.

26. The electric motor according to claim 21, wherein the even number of coils is equal to the number of the plurality of pole shoes, or the even number of coils is an integer multiple of the number of the plurality of pole shoes.

27. The electric motor according to claim 21, wherein the armature is an annular armature, and wherein the annular armature has an even number of the plurality of pole shoes and the actuator is a rotor mounted rotatably relative to the armature, and wherein the even number of coils extend in regions along a periphery of the annular armature, such that the annular armature is magnetizable with the aid of the even number of coils.

28. The electric motor according to claim 27, wherein the rotor has an integer number of the plurality of pole shoes.

29. The electric motor according to claim 27, wherein a number of coils of the even number of coils is greater than or equal to an integer multiple of the plurality of pole shoes that are arranged between two pole shoes of the plurality of pole shoes, around the annular armature.

30. The electric motor according to claim 27, wherein the annular armature or the rotor has an even-numbered rotational symmetry about a rotary axis of the rotor equal to the even number of the plurality of pole shoes of the annular armature or the even number of the plurality of pole ends.

31. The electric motor according to one of claim 27, wherein a drive axis is arranged in the rotary axis of the rotor, about which a drive axis the rotor is mounted rotatably in the annular armature.

32. The electric motor according to claim 21, wherein the electric motor is a linear motor with a linear armature, and the linear armature has an odd number of the plurality of pole shoes, wherein at least one coil is arranged between each pole shoe of the plurality of pole shoes.

33. The electric motor according to claim 32, wherein the linear armature comprises one pole shoe of the plurality of pole shoes, more than a number of the even number of coils wound on the linear motor, and wherein exactly one coil of the even number of coils is arranged between two adjacent pole shoes of the plurality of pole shoes of the linear armature.

34. The electric motor according to claim 21, wherein a same number of coil windings by the even number of coils is wound between two pole shoes of the plurality of pole shoes of the armature.

35. The electric motor according to claim 34, wherein a number of windings of the coils between the plurality of pole shoes is identical apart from at least 45° of a winding.

36. The electric motor according to claim 21, wherein an electrical conductor from which the even number of coils are wound has a uniform cross section, in particular a cross section with a maximum cross section deviation of 20%.

37. The electric motor according to claim 21, wherein the magnetizable material of the armature or of the actuator includes electrically conductive layers electrically insulated from one another, and wherein an insulator is arranged between the electrically conductive layers.

38. A method for producing an electric motor, in particular a reluctance motor, in which an even number of coils are applied to an armature containing a magnetizable material, wherein the coils are arranged between a plurality of pole shoes, such that the windings of the coils surround the armature in such a manner that the even number of coils extend in regions along the armature an actuator containing a magnetizable material having at least two pole ends is mounted movably with respect to the armature.

39. The method according to claim 38, wherein the even number of coils are electrically interconnected in such a manner that, when an electrical voltage is applied to the even number of coils, the magnetic fields generated by two coils of the even number of coils, which are adjacent to a pole shoe are oriented in such a manner that, at pole shoe of the plurality of pole shoes, arranged therebetween, the same magnetic polarization is produced at the pole shoe of the plurality of pole shoes, by the two coils of the even number of coils.

40. The electric motor, in particular the reluctance motor according to claim 21, wherein the reluctance motor is configured to drive a movement of a device or part of a device.
